(19) United States
(12) Patent Application Publication
(10) Pub. No.: US 2016/0155521 A1
(43) Pub. Date: Jun. 2, 2016

(54) NEUTRON-ABSORBING GLASS AND NEUTRON-ABSORBING MATERIAL USING THE SAME, AND MANAGEMENT METHOD OF CORIUM, UNLOADING METHOD OF CORIUM, AND SHUTDOWN METHOD OF NUCLEAR REACTOR TO WHICH THE SAME IS APPLIED

(71) Applicant: HITACHI, LTD., Chiyoda-ku, Tokyo (JP)

(72) Inventors: Takashi NAITO, Tokyo (JP); Takuya AOYAGI, Tokyo (JP); Motomune KODAMA, Tokyo (JP); Ryo ISHIBASHI, Tokyo (JP)

(73) Assignee: HITACHI, LTD., Chiyoda-ku, Tokyo (JP)

(21) Appl. No.: 14/904,211

(22) PCT Filed: Jul. 19, 2013
(86) PCT No.: PCT/JP2013/069578

§ 371 Date: Jan. 11, 2016

(51) Int. Cl. G21C 9/033; C03C 3/155; C03C 3/15; G21F 1/06; G21F 9/30

(52) U.S. Cl. CPC G21C 9/033; G21F 1/06; G21F 9/30; C03C 3/15; C03C 3/155

(57) ABSTRACT

Neutron-absorbing glass that can be input into water, wherein gadolinium oxide, boron oxide, and zinc oxide are contained and B₂O₃ is contained 42 to 65 mol % in terms of oxide above.

### TECHNICAL FIELD

The present invention relates to neutron-absorbing glass and a neutron-absorbing material using the neutron-absorbing glass, and a management method of corium, an unloading method of corium, and a shutdown method of a nuclear reactor using the neutron-absorbing glass and the neutron-absorbing material.

### BACKGROUND ART

In nuclear power plants such as boiling water nuclear power plants and pressurized water nuclear power plants, a plurality of fuel assemblies containing a nuclear fuel material (uranium pellet) is loaded in a reactor core of a nuclear reactor. When fuel assemblies are unloaded. In a normal operation cycle, the size of each fuel assembly is designed such that a state of criticality is not reached alone and thus, if the fuel assemblies are unloaded one by one, there is no danger of criticality and the fuel assemblies can be unloaded safely.

However, if an accident in which the nuclear fuel material (uranium pellet) contained in a fuel assembly loaded in a nuclear core of a nuclear reactor melts should occur like the nuclear power ant in the Three Mile Island nuclear power plant, a method of safe management by preventing a state of criticality of the molten nuclear fuel material (hereinafter, referred to as “corium”) from arising is needed. The corium remains inside a reactor pressure vessel or is leaked into a containment vessel thereof. Further, the corium is a result of melting of the uranium pellet in a fuel rod inside the nuclear reactor together with a surrounding structure. It is necessary to cut and unload the corium out of the nuclear reactor and also at this point, the unloading method to prevent a state of criticality from occurring is indispensable.

Patent Literature 1 proposes a glass composition containing SiO₂, B₂O₃, Al₂O₃, La₂O₃, Gd₂O₃ and the like for transparent window glass having capabilities to block radiation such as X rays, γ rays and the like. An embodiment of Patent Literature 1 concretely discloses seven glass compositions in which SiO₂ is in the range of 18 to 30 mol %, B₂O₃ is in the range of 18 to 38 mol %, Al₂O₃ is in the range of 2.8 to 19.8 mol %, La₂O₃ is in the range of 6 to 13 mol %, and Gd₂O₃ is in the range of 15 to 20 mol %.

### CITATION LIST

### Patent Literature

Patent Literature 1: JP 2009-7194 A

### SUMMARY OF INVENTION

### Technical Problem

B (boron) generates boric acid by reacting with water thus, if glass containing B is present in water, B may be dissolved from the glass to generate boric acid, which is dissolved in water. If boric acid is dissolved in water, the inside of a reactor becomes an acidic corrosive environment and structures inside the reactor and peripheral devices may be more likely to be corroded.

The glass composition described in Patent Literature 1 improves detergent resistance and acid resistance so that burning should not arise even after cleaning. The glass composition contains large quantities of Gd (gadolinium) and B absorb a large quantity of neutrons and so can absorb neutrons, but water resistance of the glass is low and the glass poses a problem that B is dissolved when used for a long time in a state soaked in water.

An of the present invention is to improve water resistance of neutron-absorbing glass.

### Solution to Problem

To achieve the object the present invention is characterized in that neutron-absorbing glass that can be input into water includes gadolinium oxide, boron oxide and zinc oxide, wherein B₂O₃ is contained 42 to 65 mol % in terms of oxide above.

### Advantageous Effects of Invention

According to the present invention, water resistance of neutron-absorbing glass can be improved.

### BRIEF DESCRIPTION OF DRAWINGS

FIG. 1 shows outline outside views showing typical shapes of neutron-absorbing glass.

FIG. 2 is an example of an outline outside view of a neutron-absorbing material obtained by sintering B₄C powder by neutron-absorbing glass.

FIG. 3 is an example of an outline section view of the neutron absorbing material obtained by coating granular B₄C with the neutron-absorbing glass.

FIG. 4 is an example Of an outline sectional view of a state in which a neutron absorber (neutron-absorbing glass or a neutron-absorbing material) is in contact with the surface of corium.

FIG. 5 is an example of an outline sectional view of a method of safely unloading the corium inside a nuclear reactor out of the nuclear reactor.

FIG. 6 is a typical differential thermal analysis (DTA) curve of glass.

FIG. 7 is an example of an outline sectional view of equipment to produce neutron-absorbing glass.

FIG. 8 is an example of an outline sectional view of equipment to produce neutron-absorbing material.

### DESCRIPTION OF EMBODIMENT

The present invention relates to neutron-absorbing glass and a neutron-absorbing material used in a nuclear reactor in which water is used as a moderator and suitable particularly when used in water inside the reactor. The present invention also relates to a management method of corium to which the neutron-absorbing glass or the neutron-absorbing, material is applied, an unloading method of the corium, and a shutdown method, of a nuclear reactor.

Hereinafter, an embodiment of the present invention will be described.

Neutron-absorbing glass according to the present embodiment contains gadolinium oxide, boron oxide, and zinc oxide and good water resistance and neutron absorption performance can be obtained by B₂O₃ being contained 42 to 65 mol % in terms of oxide above. With improved water resistance, B having absorbed neutron is less likely to be dissolved in water, which makes it easier to treat or dispose of water. When described in the specification that the oxide is “x to y mol %”, this means that the oxide is “x mol % or more and y mol % or less” (x mol %≦oxide≦y mol %). This also applies below.

Gd is expensive, but is an element having a neutron absorption cross-sect on about 60 times as large as that of B and can increase the quantity f absorbed neutrons by Gd being contained in glass. Gadolinium oxide and boron oxide are mainly in charge of neutron absorption. Table 1 shows elements whose neutron absorption is large and their neutron absorption cross-sections. Though dependent also on the state of irradiated neutrons, an element with an increasing neutron absorption cross section tends to have higher neutron absorption performance.

The content (42 to 65 mol %) of B₂O₃ is substantially increased to increase the quantity of absorbed neutrons, but at the same water resistance decreases and thus, zinc oxide having an effect of improving water resistance is contained. Glass productivity is also improved by containing zinc oxide. Further, having the total of Gd₂O₃, B₂O₃, and ZnO 70 mol % or more in terms of oxide above is effective to achieve all of glass productivity, water resistance, and neutron absorption performance.

The preferable composition range of neutron-absorbing glass is: Gd₂O₃ is 5 to 13 mol %, B₂O₃ is 42 to 65 mol %, ZnO is 5 to 45 mol %, and the total of at least one of Al₂O₃, ZrO₂, and R₂O (R: alkali metal) is 0 to 30 mol % in terms of oxide above. By selecting Gd₂O₃ and B₂O₃ in the above ranges, high neutron absorption performance is exhibited. Moreover, glass can be produced without being crystallized and thus, glass productivity is improved. By selecting ZnO in the above range, water resistance and glass productivity can be improved. In addition, by containing appropriate quantities of Al₂O₃, ZrO₂, and R₂O, water resistance can be improved without promoting crystallization, that is, lowering glass productivity. However, if the contents are too high, high-temperature viscosity increases for Al₂O₃ and crystallization occurs for ZrO₂, which lowers glass productivity. In the case of R₂O, problems of a dramatically increased volatilization amount of B₂O₃ or conversely reduced water resistance may arise.

Particularly preferably, the total of Gd₂O₃ and B₂O₃ is 52 to 70 mol % and the total of ZnO, Al₂O₃, ZrO₂, and R₂O is 30 to 48 mol % and that Gd₂O₃ is 5 to 10 mol %, B₂O₃ is 47 to 60 mol %, ZnO is 10 to 40 mol %, Al₂O₃ is 0 to 20 mol %, ZrO₂ is 0 to 15 mol %, and R₂O is 0 to 15 mol % in terms of oxide above is particularly effective for all of neutron absorption performance, water resistance, and glass productivity.

It is desirable that R₂O be at least Li₂O. As shown in Table 1, Li has a neutron absorption cross-section smaller than that or Gd or B, but is one of elements having a large quantity of absorbed neutrons and thus, neutron absorption performance can be improved by containing Li₂O in neutron-absorbing glass. When two types or more of R₂O (for example, Li₂O and Na₂O, Li₂O and K₂O) are contained, a mixed alkali effect specific to glass can be exhibited so that glass productivity and water resistance can be improved. However, if the quantity of R₂O is too much, the volatilization amount of B may be extremely increased or conversely water resistance may be lowered during glass production and thus, care must be taken. Further, containing R₂O can exhibit an abnormal boric acid phenomenon specific to glass so that elution of B into water can be limited or prevented.

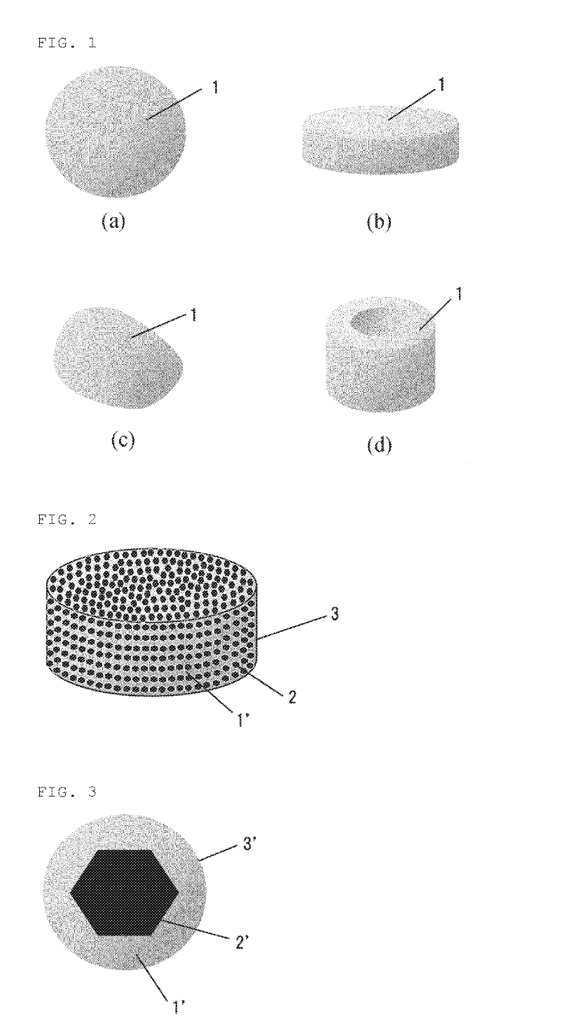

By setting the density of neutron-absorbing glass to 3.2 to 4.7 g/cm³, glass can be allowed to sink in a stable manner when input into water. By selecting an appropriate shape and size, glass can be deposited on corium in a stable manner without dancing in water due to the circulation of water. As the shape of neutron-absorbing glass 1, as shown in FIG. 1, (a) spherical, (b) tablet-shaped, (c) granular, and (d) bead-shaped can be cited. In contrast to ceramics, glass is a good thermoforming material and thus, these shapes of (a) to (d) can be produced at low cost.

An appropriate average size is desirably less than 10 mm mesh and 1 mm mesh or more. If the size is too large, glass may be caught during input or it may be difficult for glass to come into contact with corium so that glass may not be distributed over the entire corium. On the other hand, if the size is too small, glass may dance in water due to a stream. A particularly preferable average size is less than 7 mm mesh and 2 mm mesh or more.

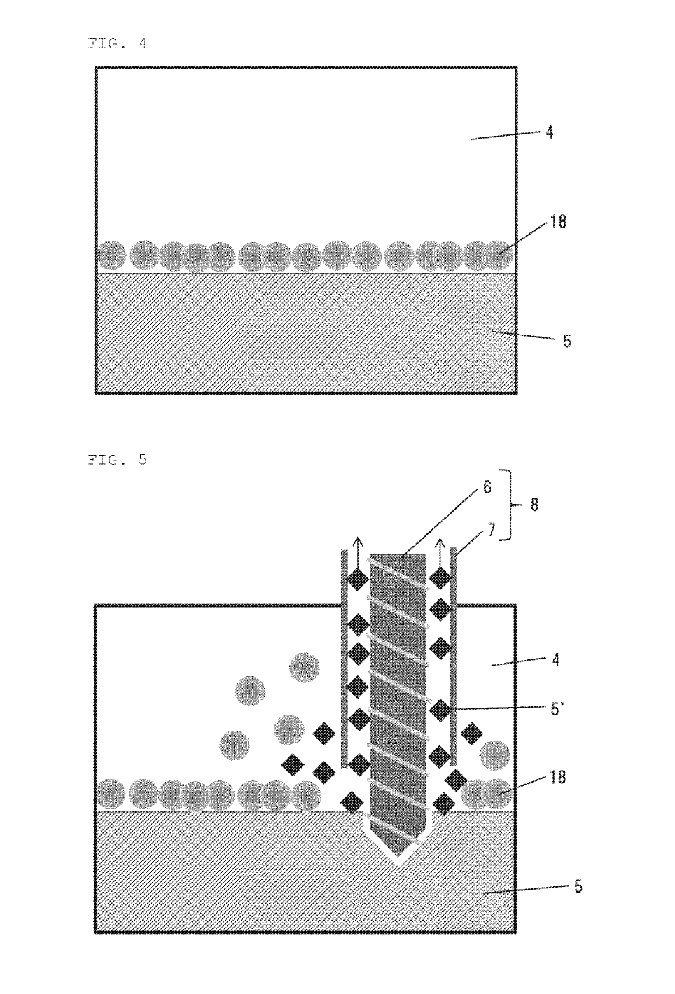

The neutron-absorbing material according to the present embodiment is, as shown in FIG. 2, a neutron-absorbing material 3 obtained by sintering B₄C (boron carbide) particles 2 containing a large number of B atoms having high neutron absorption performance by neutron-absorbing glass 1′. The neutron-absorbing material is also, as shown in FIG. 3, a neutron-absorbing material 3′ obtained by coating the surface of granular B₄C 2′ with the neutron-absorbing glass 1′. B₄O is one of generally known neutron-absorbing materials and is widely used as a neutron shield material or a nuclear reaction control material in a nuclear reactor. In a boiling water nuclear reactor, for example, a control rod filled with B₄C is used to control a nuclear fission reaction during normal operation and in an emergency. However, B₄C is hard to sinter alone and, moreover, B may be eluted into water due to surface oxidation or the like to create an acidic corrosive environment. By combining B₄C as described above and neutron-absorbing glass in the present embodiment, it becomes easier to form a desired shape and size and in addition, good water resistance and neutron absorption performance can be obtained.

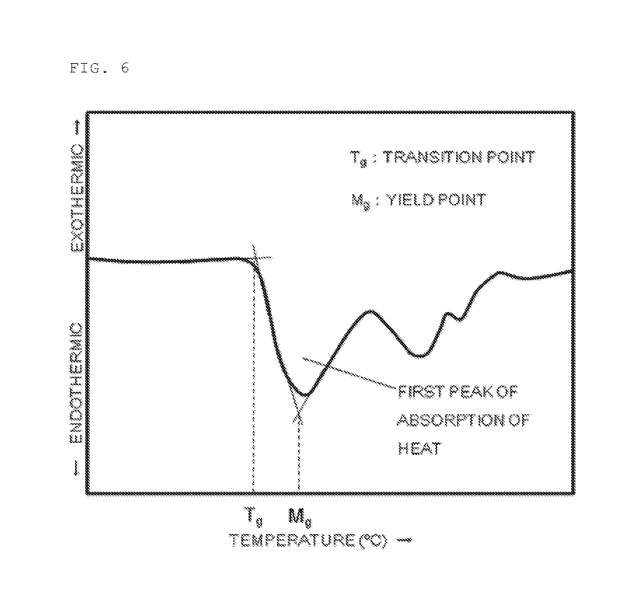

Next,the management method of corium, the unloading method of the corium, and the shutdown method of a nuclear reactor will be described. FIG. 4 shows a state in which a neutron absorber 18 (the neutron-absorbing glass 1 or the neutron-absorbing material 3 or 3′) is in contact with the surface of a containment vessel remaining inside a pressure vessel of a nuclear reactor or corium 5 leaked into the containment vessel. The neutron absorber 18 is input into water 4 from above the corium 5 managed in the water 4. With the neutron absorber 18 in contact with the corium 5 or present near the corium 5, neutrons from the corium 5 are absorbed so that a state of subcriticality of the corium can be maintained.

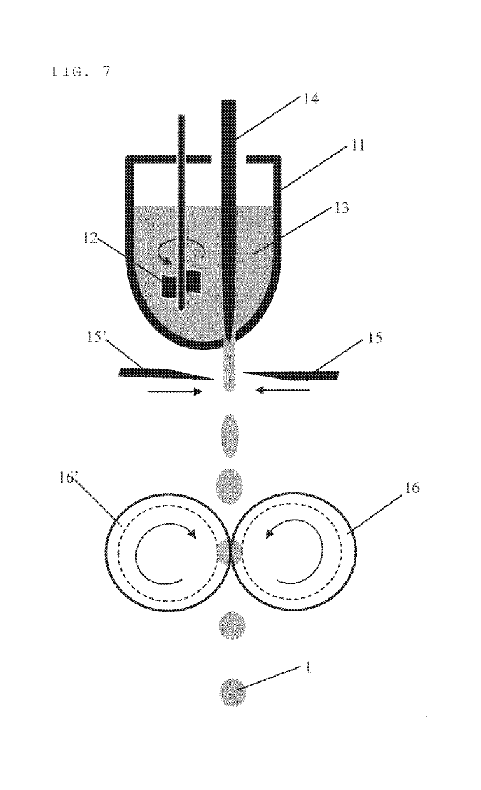

FIG. 5 shows an outline sectional view of the method of safely unloading corium in which uranium pellets inside fuel rods are melted together with surrounding structures out of the nuclear reactor. The corium 5 is excavated from the state (state in which the neutron absorber 18 is in contact with the surface of the corium 5) in FIG. 4. Though corium 5′ dances in the water due to excavation, the neutron absorber 18 also dances together with the corium 5′ so that the corium 5′ can safely be unloaded out of the nuclear reactor by preventing a state of re-criticality. If an excavator 8 having a siphon 7 around a drill 6 is used, the corium 5′ excavated can be sucked while cutting and thus, the quantity scattered around can be reduced so that the corium can be unloaded out of the nuclear reactor more safely.

The shutdown method of a nuclear reactor according to the present embodiment is a method of shutting down a nuclear reactor in an emergency and a state of criticality can be prevented from being reached by inputting neutron-absorbing glass or neutron-absorbing materials according to the present embodiment into the nuclear reactor so that the neutron-absorbing glass or neutron-absorbing materials according to the present embodiment are piled up around fuel rods inside the nuclear reactor.

Hereinafter, glass productivity (ease of production), water resistance, density, characteristic temperature, and neutron absorption performance, which are evaluation items of the neutron-absorbing glass, will be described.

The productivity of neutron-absorbing glass is evaluated in a glass state produced at 1300 to 1400° C. Glass materials of 500 g in which predetermined amounts are formulated and mixed are put into a crucible and heated up to 1300 to 1400° C. at a rate of temperature rise of about 10° C./min in an electric furnace to melt the glass materials. The glass materials are stirred to make the glass uniform during the process and held for 2 to 3 hours. Then, the crucible is taken out of the electric furnace and the melt therein is poured into a stainless jig pre-heated to about 250° C. to produce glass.

If transparent glass is obtained under the above glass production conditions, the glass is evaluated as acceptable “◯” and if glass is crystallized (opacity), the glass is evaluated as unacceptable “×”. Even if the glass is in an uniform transparent glass state, if the quantity of volatility is large during glass production or if the glass has high-temperature viscosity and it is difficult to pour the glass, the glass is evaluated as “Δ”. If the glass productivity is good, good formability by heat is obtained and neutron-absorbing glass of various shapes as shown in FIG. 1 and various sizes can easily be obtained.

The water resistance of neutron-absorbing glass is determined based on a state of produced glass after putting the glass into an aqueous solution whose salinity concentration is 0.9% by weight and boiling the solution for three hours. If there is no change in appearance of glass and no corrosion is recognized, the glass is evaluated as acceptable “◯” and if dimming arises on the surface of glass or the structure is glass collapses, the glass is evaluated as unacceptable “×”. In addition, pH of water after the test is measured and if the water is acidic, the glass is evaluated as “Δ” even if there is no change in appearance.

The density of neutron-absorbing glass is measured by grinding the glass to powder and using a pycnometer method using a helium gas.

As characteristic temperatures of neutron-absorbing glass, the glass is ground to powder and a transition point Tg and a yield point Mg are measured based on differential thermal analysis (DTA). FIG. 6 shows a typical DTA curve of glass. The start temperature of the first peak of absorption of heat is the transition point Tg and the peak temperature thereof is the yield point Mg. These characteristic temperatures are defined based on viscosity and Tg corresponds to a temperature at which the viscosity is 1013.3 poises and Mg corresponds to a temperature at which the viscosity is 1011 poises.

For the neutron absorption performance of neutron-absorbing glass, the neutron absorption cross-section per unit volume is calculated using the quantities of the Gd element, B element, and Li element per unit volume determined from the composition and density of glass and the neutron absorption cross-sections of respective elements shown in Table 1 and if the density is equal to or larger than 2.52 g/cm³ of B₄C, the glass is evaluated as acceptable “◯”, and if the density falls below 2.52 g/cm³, the glass is evaluated as unacceptable “×”.

Hereinafter, further details will be provided using examples. However, the present invention is not limited to examples described here.

### EXAMPLE 1

In Example 1, the composition and characteristics of neutron-absorbing glass are examined. The example is shown in Table 2 and a comparative example is shown in Table 3. For the production of glass, reagents Gd₂O₃, B₂O₃, ZnO, Al₂O₃, ZrO₂, Li₂CO₃, Na₂CO₃, K₂CO₃, SiO₂, MgO, CaCO₃, SrCO₃, and BaCO₃ manufactured by Kojundo Chemical Laboratory Co., Ltd. are used as materials.

As shown in Table 2, glass in Examples A-01 to 30 is all acceptable in neutron absorption performance, water resistance, and class productivity. Also, the density of glass is in the range of 3.2 to 4.7 g/cm³ and the glass can be allowed to sink in a stable manner after being input into water. The density of B₄C is 2.52 g/cm³ and the density of glass is larger than this density. Further, the transition point Tg and the yield point Mg as characteristic temperatures are not high, which makes secondary treatment by heat easier. More specifically, (a) spherical shown in FIG. 1 can be chanced to (b) tablet-shaped by hot-pressing or to (c) granular by heating cullet.

In Comparative Examples B-01 to 25 in Table 3, in contrast to Examples A-01 to 30 shown in Table 2, some comparative examples are acceptable in glass productivity, but none is acceptable in both water resistance and neutron absorption performance. Comparative Examples B-01, B-02 are common borosilicate glass and zinc borate glass and are excellent in glass productivity and water resistance. However, the Gd element that absorbs a large quantity of neutrons is not contained and thus, compared with Examples A-01 to 30, the neutron absorption cross-section ratio is extremely small and Comparative Examples B-01, B-02 are inferior to B₄C in neutron absorption performance. The density of Comparative Example B-02 is larger than that of B₄C, but the density of Comparative Example B-01 is smaller than that of B₄C. Comparative Examples B-03 to 05 are Gd₂O—B₂O₃ based glass or Gd₂O₃—B₂O₃—SiO₂ based glass and glass productivity thereof is good, but the content of B₂O₃ is very high and water resistance thereof is insufficient. Comparative Example B-06 is also Gd₂O₃—B₂O₃—SiO₂ based glass, but the content or SiO₂ is high and thus, high-temperature viscosity thereof is large, leading to poor glass productivity. Also, water resistance thereof is not sufficient.

Comparative Examples B-07 to 18 contain generally known ZnO, Al₂O₃, ZrO₂, or alkaline-earth oxide to improve water resistance and glass productivity of Gd₂O₃—B₂O₃—SiO₂ based glass. However, crystallization leads to opacity and sufficient water resistance cannot be obtained. It turns out that inclusion of ZnO, Al₂O₃, ZrO₂, or alkaline-earth oxide in Gd₂O₃—B₂O₃—SiO₂ based glass does not lead to improvements of glass productivity and water resistance. Further, in Comparative Examples B-19 to 25, inclusion of alkali metal oxide is examined and only Comparative Example B-19 that contains none of Al₂O₃, ZnO, ZrO₂, and alkaline-earth oxide becomes uniform transparent glass and in others, like in Comparative Examples B-07 to 18, crystallization leads to opacity. However, Comparative Example B-19 contains a large quantity of alkali metal oxide and thus, the volatilization amount of B₂O₃ is large and also water resistance is insufficient. Water resistance of Comparative Examples B-20 to 25 in which opacity (crystallization) occurs is not good like in Comparative Examples B-07 to 18.

From examination results Of Examples A-01 to 30 and Comparative Examples B-01 to 25 described above, we found that as neutron-absorbing glass that can be input into water, all of glass productivity water resistance, and neutron absorption performance can be improved containing gadolinium oxide, boron oxide, and zinc oxide and B₂O₃ is 42 to 65 mol % in terms of oxide above.

### EXAMPLE 2

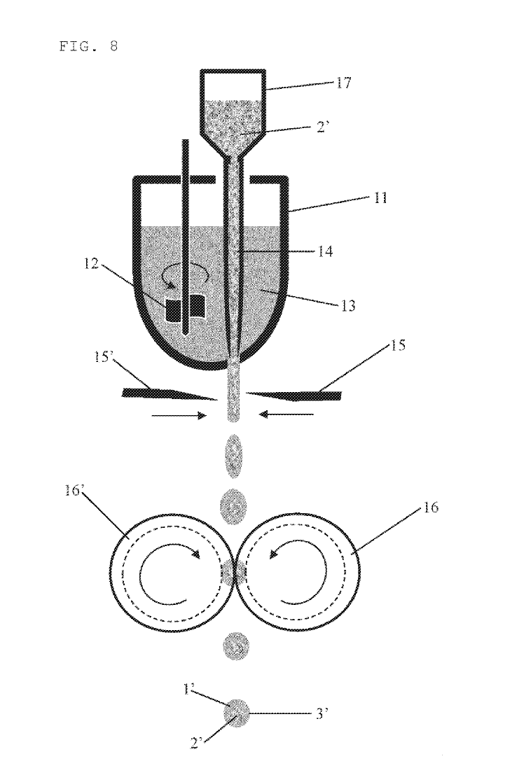

In Example 2, the shape and size of neutron-absorbing glass is examined. Formability by heat of glass is good and thus, the production of neutron-absorbing glass of various shapes and sizes is attempted. First, the (a) spherical neutron-absorbing glass 1 shown in FIG. 1 is produced. The glass of Example A-20 in Table 2 is used for the neutron-absorbing glass 1. The equipment used is shown in FIG. 7. The equipment is basically the same as equipment to manufacture marbles.

In FIG. 7, the neutron-absorbing glass in Example A-20 is melted in a glass melting furnace 11 at 1300 to 1400° C. and molten glass 13 is attempted to be made u form by rotating a stirring blade 12. A predetermined amount of the molten glass 13 is caused to flow out by lifting a plunger 14 from a lower portion of the glass melting furnace 11 and is sequentially cut by cutters 15, 15′ to allow the molten class to drop between rotating forming rolls 16, 16′. The surfaces of the forming rolls 16, 16′ are consecutively provided with grooves in a semispherical shape to make the molten glass 13 spherical and grooves thereof face each other. The molten glass 13 having passed between the forming rolls 16, 16′ is cooled and also is made the neutron-absorbing glass 1 in a spherical shape. Then, to remove thermal strain of the obtained neutron-absorbing glass 1 in a spherical shape, annealing is performed at a temperature a little higher than the transition point Tg. The transition point Tg of Example A-20 is 493° C. and thus, annealing is performed by heat treatment at about 500° C. By removing thermal strain, mechanical strength and water resistance of the neutron-absorbing glass can be improved.

The average size of the neutron-absorbing glass 1 in a spherical shape can roughly be controlled the outflow amount of the molten glass 13 from the glass melting furnace 11, the cutting rate of the cutters 15, 15′, and the groove size on the surface of the forming rolls 16, 16′ In the present embodiment, the diameter thereof is adjusted to be about 5 mm. Then, the sizes or less than 10 mm mesh and 1 mm mesh or more are obtained by using sieves of 10 mm mesh and 1 mm mesh. In this range of size, neutron-absorbing glass in a spherical shape can be obtained at high yield rates. If the size thereof is 10 mm or more, glass may be caught while being input into water or it may be difficult for glass to come into contact with corium so that glass may not be distributed over the entire corium. If the size thereof is less than 1 mm, on the other hand, glass may dance in water due to a stream. Preferably, the size is set to less than 7 mm mesh and 2 mm mesh or more by using sieves of 7 mm mesh and 2 mm mesh.

Next, (b) tablet-shaped neutron-absorbing glass shown in FIG. 1 is produced like the above case using the glass of Example A-20. For the production of tablet-shaped neutron-absorbing glass, neutron-absorbing glass produced in a spherical shape is crushed by hot-pressing. Then, like the above case, annealing is performed and further the glass is sifted through sieves to obtain the desired size. When compared with the spherical shape, the tablet shape is less likely to roll and so is handled more easily. In addition, table-shaped glass has a larger surface area than spherical glass per the same weight so that improvements of neutron absorption performance can also be expected.

(c) Granular neutron-absorbing glass shown in FIG. 1 is also produced like the above case using the glass of Example A-20. First, glass of Example A-20 is melted and produced and then crushed to cullet of an appropriate size by a crusher. The cullet is heated up to about 750° C. by a tunnel furnace and made granular by rounding edges. Annealing is also performed in the same tunnel furnace at the same time. Then, like the above case, the desired size is obtained by sifting glass through sieves.

(d) Bead-shaped neutron-absorbing glass shown in FIG. 1 is also produced like the above case using the glass of Example A-20. First, a glass tube of about 5 mm in diameter is produced from the glass of Example A-20. The glass tube is scratched at intervals of about 5 mm and cut by a thermal shock. Cut gas tubes are heated up to about 750° C. by a tunnel furnace like the above case and made bead-shaped by rounding edges. Annealing is also performed in the same tunnel furnace at the same time. Then, like the above case, the desired size is obtained sifting glass through sieves. The surface area can further be increased by the bead shape, which is considered to be able to contribute to improvements of neutron absorption performance.

### EXAMPLE 3

In Example 3, compounding neutron-absorbing glass and B₄C is examined. Powder neutron-absorbing glass and powder of B₄C mixed, molded in a die, and heated in a hypoxia atmosphere to produce a sintered body f a neutron-absorbing material shown in FIG. 2. The reason for heating in a hypoxia atmosphere is to limit or prevent even a small amount of oxygen of B₄C. The glass of Example A-14 shown in Table 2 is used as the neutron absorbing glass and is ground to 30 μm or less by a stamp mill and a let mill. Powder of B₄C on the market whose size is 150 μm or less is used as B₄C. Powder of neutron-absorbing glass of Example A-14 and B₄C powder are formulated and mixed in a ratio of 25% by volume and 75% by volume to produce a large number of columnar molded bodies of 5 mm in diameter and 5 mm in thickness under the condition of 1 ton/cm² by using a die. These molded bodies are passed to a tunnel furnace in a hypoxia atmosphere and the glass powder of Example A-14 is softened and fluidized at about 800° C. to produce a sintered body of the neutron-absorbing material. The obtained sintered body has contracted by about 10 to 20% by volume.

As a result of performing the same water resistance test as that in Example 1 using the obtained sintered body, good water resistance without being corroded can be obtained. The glass of Example A-14 and B₄C both has a large neutron absorption cross-section per unit volume and thus, neutron absorption performance is good. On the other hand, B₄C alone may generate boric acid by gradually reacting with water in the water to create an acidic corrosive environment. By combining with neutron-absorbing glass, the area where B₄C is in contact with water can be reduced and also, with high water resistance of the neutron-absorbing glass, B is less likely to be dissolved into water even after a long period of exposure to water. In addition, a sintered body of B₄C can be produced more easily. Further, the density can be increased when compared with a case in which B₄C is used alone, the sintered body is less likely to be moved by a stream. The neutron-absorbing material is not limited to the use of being input into water and may also be developed for replacement of B₄C powder loaded into a control rod or for replacement of a B₄C sintered body used in a fast reactor.

### EXAMPLE 4

Also in Example 4, like in Example 3, compounding neutron-absorbing glass and B₄C is examined and the neutron-absorbing material 3′ shown in FIG. 3 is produced. The glass of Example A-25 shown in Table 2 is used as the neutron-absorbing glass 1′. Granular particles on the market of 1 to 3 mm in size are used as B₄C particles 2′. The equipment used to produce the neutron-absorbing material shown in FIG. 3 is shown in FIG. 8. The equipment shown in FIG. 7 is devised such that the granular B₄C particles 2′ can be input from the plunger 14 into the molten glass 13 at 1300 to 1400° C. to obtain the equipment in FIG. 8. The B₄C particles 2′ are introduced into a container 17 above the glass melting furnace 13 and heated by remaining heat of the glass melting furnace 13. To prevent oxidation of B₄C, an inert atmosphere is introduced into the container 17. The granular B₄C particles 2′ are sequentially input from the container 17 so as to be dropped from the lower portion of the glass melting furnace 11 together with the molten glass 13. The B₄C particles 2′ are cut by the cutters 15, 15′ like in Example 2 and dropped between the forming rolls 16, 16′ to produce the neutron-absorbing material 3′ in a spherical shape as shown in FIG. 3.

FIG. 3 shows an example in which the surface portion of one B4C particle is coated with neutron-absorbing glass, but in Example 4, there are many cases in which a plurality or B₄C particles is contained. This causes no problem as long as the size of the neutron-absorbing material 3′ does not become too large. Then, the obtained neutron-absorbing material 3′ is thermally treated at a temperature of about 510° C., which is a little higher than the transition point Tg of Example A-25, to remove thermal strain of the neutron-absorbing glass 2′.

The same water resistance test as that of Example 1 is performed using the obtained neutron-absorbing material. As a result, good water resistance without being corroded can be obtained. Regarding the neutron absorption performance, the glass of Example A-25 and B₄C both have a large neutron absorption cross-section per unit volume and thus, it is needless to say that neutron absorption performance is good. When compared with Example 3, there is no need to grind neutron-absorbing glass to powder and mix with B₄C powder uniformly for molding and sintering in Example 4 and therefore, neutron-absorbing materials can be produced from neutron-absorbing glass and B₄C at low costs. Also, like Example 3, the neutron-absorbing material is not limited to the use of being input into water and may also be developed for replacement of B₄C powder loaded into a control rod or for replacement of a B₄C sintered body used in a fast reactor.

### EXAMPLE 5

In Example 5, an example of the management method of corium to which the neutron-absorbing glass or neutron-absorbing material according to the present invention examined in Examples 1 to 4 is applied described above will be described.

To maintain subcriticality of corium and to promote safety, the neutron-absorbing glass or neutron-absorbing material is input into a nuclear reactor. In FIG. 4, the corium 5 as a lump is sunk in the water 4 and the neutron absorber 18 (neutron-absorbing glass, neutron-absorbing material) is input into the water 4 to be in direct contact with the corium 5 like covering the top surface of the lump. The density of the neutron absorber 18 is sufficiently larger than that of water and thus, the absorber is easily deposited on the surface of the corium 5. If there is a crack in the lump of the corium 5 or a there is a gap between lumps of the corium 5, the neutron absorber 18 enters such a crack or a gap. Accordingly, even if positive reactivity is applied to the corium 5 for some reason, a state of criticality can be prevented from being reached by shielding neutrons generated from the corium 5 to inhibit a chain reaction. It is effective to make the size of the neutron absorber 18 smaller than the lump of the corium 5.

The neutron-absorbing glass is uniform transparent glass, but has a property of being colored when irradiated with neutrons. With an increasing amount of irradiation of neutrons, the degree or coloring tends to increase and thus, by checking the degree of coloring of neutron-absorbing glass according to the present invention input into a nuclear reactor, it becomes possible to detect or predict the location of corium inside the reactor.

### EXAMPLE 6

In Example 6, an example of the unloading method of corium to which the neutron-absorbing glass or neutron-absorbing material examined in Examples 1 to 4 described above is applied will be described.

As shown in FIG. 5, the neutron absorber 18 is input into the nuclear reactor to prevent a state of re-criticality during unloading work of the corium 5. FIG. 5 shows a state in which the corium 5 is shredded by the drill 6 of the excavator 8 and the corium 5′ in a particulate state is sucked via the siphon 7 of the excavator 8. In this case, a portion of the excavated corium 5′ in a particulate state may be scattered into the water 4 around without being sucked into the siphon 7 of the excavator 8. In such a state, there is a danger of a state of re-criticality with a changed volume ratio of the corium 5′ in a particulate state in the water 4. Thus, neutrons in the water 4 can be made absorbable and blockable by scattering the neutron absorber 18 together with the corium 5′ in a particulate state scattered into the water 4. Accordingly, the chain reaction can be inhibited so that a state of re-criticality is prevented from being reached during excavation work. In addition, even if the neutron absorber 18 is damaged during excavation work by being drilled by the drill 6 of the excavator 8 or the like, neutron absorption performance will not be impaired.

The above corium is described by taking a method of digging by excavation using a drill as an example, but the method of digging is not limited to the excavator and may also use a power shovel.

### EXAMPLE 7

In Example 7, an example of controlling a nuclear fission reaction of a nuclear reactor by inputting the neutron-absorbing glass or neutron-absorbing material will be described.

As a method of emergency shutdown of a nuclear reactor other than the control rod, a method of injecting water of boric acid into the nuclear core of the nuclear reactor has been known. However, the injection of water of boric acid into the nuclear core may change the inside of the reactor to an acidic corrosive environment.

Thus, instead of injecting water of boric acid, the neutron-absorbing glass or neutron-absorbing material is input such that the neutron-absorbing glass or neutron-absorbing material is deposited around fuel rods inside the nuclear reactor. Accordingly, an emergency shutdown of the nuclear reactor can be performed by control ling the nuclear fission reaction of the nuclear reactor. When the neutron-absorbing glass or neutron-absorbing material is used, boric acid can be prevented from eluting into water inside the nuclear reactor or if boric acid elutes, pH can be prevented from decreasing. Thus, corrosion of structures inside the reactor can be prevented and also the reaction of nuclear fuel can be continued to be inhibited and therefore, the nuclear reactor can be shut down for a long period of time.

TABLE 1
Elements of large neutron absorption

| | | Neutron absorption |
|---|---|---|
| Element | Atomic number | cross-section (barn) |
| Li | 3 | 71 |
| B | 5 | 759 |
| Rh | 45 | 155 |
| Cd | 48 | 2450 |
| In | 49 | 194 |
| Sm | 62 | 5800 |
| Eu | 63 | 4300 |
| Gd | 64 | 46000 |
| Dy | 66 | 940 |
| Er | 68 | 160 |
| Tm | 69 | 125 |
| Hf | 72 | 105 |
| Hg | 80 | 360 |

TABLE 2
Examples

| | | | | | | | Neutron | | | | Characteristic | |
|---|---|---|---|---|---|---|---|---|---|---|---|---|
| | Composition (mol %) | | | | | | absorption | | | | temperature (° C.) | |
| Glass | | | | | | Alkali metal | area ratio | Water | Glass | Density | Transition | Yield |
| No. | Cd₂O₃ | B₂O₃ | ZnO | Al₂O₃ | ZrO₂ | oxide | (B₄C ratio) | resistance | productivity | (g/cm³) | point T_{g} | point M_{g} |
| A-01 | 13 | 42 | 45 | — | — | — | ◯ (3.73) | ◯ | ◯ | 4.67 | 557 | 584 |
| A-02 | 12 | 45 | 43 | — | — | — | ◯ (3.47) | ◯ | ◯ | 4.51 | 566 | 595 |
| A-03 | 10 | 60 | 30 | — | — | — | ◯ (2.70) | ◯ | ◯ | 3.83 | 587 | 635 |
| A-04 | 10 | 55 | 35 | — | — | — | ◯ (2.90) | ◯ | ◯ | 4.13 | 580 | 621 |
| A-05 | 10 | 55 | 5 | 10 | 10 | Li₂O: 5, Na₂O: 5 | ◯ (2.76) | ◯ | ◯ | 4.05 | 524 | 565 |
| A-06 | 10 | 50 | 40 | — | — | — | ◯ (2.95) | ◯ | ◯ | 4.22 | 575 | 611 |
| A-07 | 10 | 50 | 30 | 10 | — | — | ◯ (2.89) | ◯ | ◯ | 4.18 | 588 | 642 |
| A-08 | 10 | 50 | 30 | — | 10 | — | ◯ (2.89) | ◯ | ◯ | 4.29 | 584 | 532 |
| A-09 | 10 | 50 | 30 | — | — | Li₂O: 5, Na₂O: 5 | ◯ (2.88) | ◯ | ◯ | 4.00 | 512 | 541 |
| A-10 | 10 | 45 | 45 | — | — | — | ◯ (3.00) | ◯ | ◯ | 4.41 | 563 | 598 |
| A-11 | 10 | 42 | 38 | — | — | Li₂O: 5, Na₂O: 5 | ◯ (2.99) | ◯ | ◯ | 4.28 | 498 | 527 |
| A-12 | 8 | 60 | 7 | — | 12 | Li₂O: 7, Na₂O: 6 | ◯ (2.15) | ◯ | ◯ | 3.52 | 538 | 583 |
| A-13 | 8 | 57 | 12 | 17 | — | Li₂O: 3, Na₂O: 3 | ◯ (2.02) | ◯ | ◯ | 3.32 | 565 | 623 |
| A-14 | 8 | 55 | 11 | 14 | — | Li₂O: 6, Na₂O: 6 | ◯ (2.02) | ◯ | ◯ | 3.26 | 513 | 565 |
| A-15 | 8 | 55 | 31 | — | — | Li₂O: 3, Na₂O: 3 | ◯ (2.37) | ◯ | ◯ | 3.78 | 536 | 568 |
| A-16 | 8 | 54 | 23 | 10 | 5 | — | ◯ (2.30) | ◯ | ◯ | 3.95 | 586 | 628 |
| A-17 | 8 | 54 | 22 | — | 4 | Li₂O: 6, Na₂O: 6 | ◯ (2.31) | ◯ | ◯ | 3.69 | 505 | 538 |
| A-18 | 8 | 52 | 21 | 4 | 3 | Li₂O: 6, Na₂O: 6 | ◯ (2.24) | ◯ | ◯ | 3.63 | 516 | 546 |
| A-19 | 8 | 47 | 15 | 15 | — | Li₂O: 7, | ◯ (2.10) | ◯ | ◯ | 3.48 | 502 | 538 |
| | | | | | | Na₂O: 4, K₂O: 4 | | | | | | |
| A-20 | 7 | 54 | 22 | 5 | — | Li₂O: 6, Na₂O: 6 | ◯ (2.05) | ◯ | ◯ | 3.55 | 493 | 534 |
| A-21 | 7 | 50 | 25 | 6 | 3 | Li₂O: 4, | ◯ (1.98) | ◯ | ◯ | 3.63 | 522 | 553 |
| | | | | | | Na₂O: 3, K₂O: 2 | | | | | | |
| A-22 | 7 | 48 | 23 | 12 | — | Li₂O: 10 | ◯ (2.02) | ◯ | ◯ | 3.59 | 524 | 559 |
| A-23 | 7 | 47 | 21 | — | 15 | Li₂O: 5, K₂O: 5 | ◯ (1.81) | ◯ | ◯ | 3.52 | 525 | 557 |
| A-24 | 6 | 54 | 25 | 5 | 5 | Li₂O: 3, Na₂O: 2 | ◯ (1.74) | ◯ | ◯ | 3.52 | 506 | 541 |
| A-25 | 6 | 52 | 21 | 5 | 4 | Li₂O: 6, Na₂O: 6 | ◯ (1.78) | ◯ | ◯ | 3.49 | 499 | 532 |
| A-26 | 6 | 50 | 30 | — | 10 | Li₂O: 2, Na₂O: 2 | ◯ (1.72) | ◯ | ◯ | 3.60 | 515 | 557 |
| A-27 | 6 | 49 | 15 | 20 | — | Li₂O: 5, Na₂O: 5 | ◯ (1.63) | ◯ | ◯ | 3.31 | 543 | 576 |
| A-28 | 5 | 65 | 30 | — | — | — | ◯ (1.70) | ◯ | ◯ | 3.71 | 592 | 643 |
| A-29 | 5 | 50 | 30 | 5 | 5 | Li₂O: 5 | ◯ (1.55) | ◯ | ◯ | 3.56 | 549 | 580 |
| A-30 | 5 | 50 | 20 | 10 | — | Li₂O: 8, Na₂O: 7 | ◯ (1.55) | ◯ | ◯ | 3.48 | 482 | 520 |

TABLE 3
Comparative Examples

| | | | | | | | | | | | | | Characteristic | |
|---|---|---|---|---|---|---|---|---|---|---|---|---|---|---|
| | Composition (mol %) | | | | | | | | Neutron | | | | temperature (° C.) | |
| | | | | | | | Alkali | Alkaline- | absorption | Water | Glass | | Transi- | Yield |
| Glass | | | | | | | metal | earth | area ratio | resis- | produc- | Density | tion | point |
| No. | Cd₂O₃ | B₂O₃ | SiO₂ | ZnO | Al₂O₃ | ZrO₂ | oxide | oxide | (B₄C ratio) | tance | tivity | (g/cm³) | point T_{g} | M_{g} |
| B-01 | — | 25 | 65 | — | 4 | — | — | — | X (0.10) | ◯ | ◯ | 2.36 | 487 | 558 |
| B-02 | — | 40 | 10 | 50 | — | — | — | — | X (0.20) | ◯ | ◯ | 3.51 | 539 | 572 |
| B-03 | 20 | 80 | — | — | — | — | — | — | — | X | ◯ | — | — | — |
| B-04 | 20 | 70 | 10 | — | — | — | — | — | — | X | ◯ | — | — | — |
| B-05 | 10 | 70 | 20 | — | — | — | — | — | — | Δ | ◯ | — | — | — |
| B-06 | 7 | 50 | 43 | — | — | — | — | — | — | Δ | Δ (High | — | — | — |
| | | | | | | | | | | | viscosity) | | | |
| B-07 | 30 | 25 | 25 | — | 20 | — | — | — | — | X | X (Opacity) | — | — | — |
| B-08 | 15 | 40 | 35 | — | 10 | — | — | — | — | X | X (Opacity) | — | — | — |
| B-09 | 20 | 40 | 30 | 10 | — | — | — | — | — | X | X (Opacity) | — | — | — |
| B-11 | 7 | 52 | 25 | — | — | 10 | — | MgO: 6 | — | X | X (Opacity) | — | — | — |
| B-12 | 20 | 30 | 35 | — | — | — | — | MgO: 5, | — | X | X (Opacity) | — | — | — |
| | | | | | | | | CaO: 10 | | | | | | |
| B-13 | 8 | 54 | 30 | — | — | — | — | SrO: 4, | — | X | X (Opacity) | — | — | — |
| | | | | | | | | BaO: 4 | | | | | | |
| B-14 | 25 | 20 | 30 | 5 | 15 | 5 | — | — | — | X | X (Opacity) | — | — | — |
| B-15 | 20 | 25 | 30 | 15 | 6 | 4 | — | — | — | X | X (Opacity) | — | — | — |
| B-16 | 20 | 30 | 30 | 10 | 7 | 3 | — | — | — | X | X (Opacity) | — | — | — |
| B-17 | 15 | 35 | 25 | 5 | 10 | 10 | — | — | — | X | X (Opacity) | — | — | — |
| B-18 | 10 | 45 | 25 | — | 10 | 10 | — | — | — | X | X (Opacity) | — | — | — |
| B-19 | 7 | 47 | 20 | — | — | — | Li₂O: 13, | — | — | X | Δ (Volati- | — | — | — |
| | | | | | | | Na₂O: 13 | | | | lization) | | | |
| B-20 | 8 | 53 | 25 | — | — | — | Li₂O: 3, | SrO: 4, | — | X | X (Opacity) | — | — | — |
| | | | | | | | Na₂O: 3 | BaO: 4 | | | | | | |
| B-21 | 7 | 48 | 27 | — | — | 6 | Li₂O: 6, | — | — | X | X (Opacity) | — | — | — |
| | | | | | | | Na₂O: 6 | | | | | | | |
| A-22 | 7 | 48 | 25 | — | 5 | 5 | Na₂O: 5, | — | — | X | X (Opacity) | — | — | — |
| | | | | | | | K₂O: 5 | | | | | | | |
| A-23 | 10 | 40 | 20 | — | 15 | — | Li₂O: 7, | — | — | X | X (Opacity) | — | — | — |
| | | | | | | | K₂O: 8 | | | | | | | |
| A-24 | 7 | 43 | 14 | — | 8 | — | Li₂O: 14, | — | — | X | X (Volati- | — | — | — |
| | | | | | | | Na₂O: 14 | | | | lization, | | | |
| | | | | | | | | | | | opacity) | | | |
| A-25 | 20 | 35 | 25 | 5 | 5 | — | Na₂O: 2, | BaO: 5 | — | X | X (Opacity) | — | — | — |
| | | | | | | | K₂O: 3 | | | | | | | |

### REFERENCE SIGNS LIST

1, 1′: Neutron-absorbing glass

2, 2′: B₄C particle

3, 3′: Neutron-absorbing material

4: In water

5, 5′: Corium

6: Drill

7: Siphon

8: Excavator

11: Glass melting furnace

12: Stirring blade

13: Molten glass

14: Plunger

15, 15′: Cutter

16, 16′: Forming roll

17: Container

18: Neutron absorber

1. Neutron-absorbing glass that can be input into water, comprising:
gadolinium oxide;
boron oxide; and
zinc oxide, wherein
B₂O₃ is contained 42 to 65 mol % in terms of oxide above.

2. The neutron-absorbing glass according to claim 1, wherein a total of Gd₂O₃, B₂O₃, and ZnO is 70 mol % or more in terms of oxide above.

3. The neutron-absorbing glass according to claim 1, wherein Gd₂O₃ is contained 5 to 13 mol %, B₂O₃ is contained 42 to 65 mol %, and ZnO is contained 5 to 45 mol % in terms of oxide above and also a total of at least one of Al₂O₃, ZrO₂, and R₂O (R: alkali metal) is contained 0 to 30 mol %.

4. The neutron-absorbing glass according to claim 1, wherein a total of Gd₂O₃ and B₂O₃ is 52 to 70 mol % and the total of ZnO, Al₂O₃, ZrO₂, and R₂O is 30 to 48 mol % in terms of oxide above.

5. The neutron-absorbing glass according to claim 1, wherein Gd₂O₃ is contained 5 to 10 mol %, B₂O₃ is contained 47 to 60 mol %, ZnO is contained 10 to 40 mol %, Al₂O₃ is contained 0 to 20 mol %, ZrO₂ is contained 0 to 15 mol %, R₂O is contained 0 to 15 mol %.

6. The neutron-absorbing glass according to claim 3, wherein the R₂O contains at least Li₂O.

7. The neutron-absorbing glass according to claim 1, wherein a density of the neutron-absorbing glass is 3.2 to 4.7 g/cm³.

8. The neutron-absorbing glass according to claim 1, wherein a shape of the neutron-absorbing glass is granular, spherical, tablet-shaped, or bead-shaped.

9. The neutron-absorbing glass according to claim 1, wherein an average size of the neutron-absorbing glass is less than 10 mm mesh and 1 mm mesh or more.

10. A neutron-absorbing material comprising: B4C powder and the neutron-absorbing glass according to claim 1.

11. A neutron-absorbing material, wherein a surface of granular B4C is coated with the neutron-absorbing glass according to claim 1.

12. A management method of corium inside a pressure vessel or a containment vessel of a nuclear reactor, comprising:
inputting the neutron-absorbing glass according to claim 1 toward the corium arranged in water to bring the neutron-absorbing glass into contact with a surface of the corium.

13. A management method of corium inside a pressure vessel or a containment vessel of a nuclear reactor, comprising:
inputting the neutron-absorbing material according to claim 10 toward the corium arranged in water to bring the neutron-absorbing material into contact with a surface of the corium.

14. An unloading method of corium inside a nuclear reactor, comprising:
inputting the neutron-absorbing glass according to claim 1 toward the corium arranged in water to bring the neutron-absorbing glass into contact with a surface of the corium; and
crushing the corium to unload the corium out of the nuclear reactor.

15. An unloading method of corium inside a nuclear reactor, comprising:
inputting the neutron-absorbing material according to claim 10 toward the corium arranged in water to bring the neutron-absorbing material into contact with a surface of the corium; and
crushing the corium to unload the corium out of the nuclear reactor.

16. The unloading method of corium according to claim 14, wherein the corium is unloaded out of the nuclear reactor by being crushed and sucked.

17. The unloading method of corium according to claim 15, wherein the corium is unloaded out of the nuclear reactor by being crushed and sucked.

18. A shutdown method of a nuclear reactor, comprising: inputting the neutron-absorbing glass according to claim 1 into the nuclear reactor to deposit the neutron-absorbing glass around a fuel rod inside the nuclear reactor.

19. A shutdown method of a nuclear reactor, comprising: inputting the neutron-absorbing material according to claim 10 into the nuclear reactor to deposit neutron-absorbing material around a fuel rod inside the nuclear reactor.
